(19) United States
(12) Patent Application Publication
(10) Pub. No.: US 2014/0144079 A1
(43) Pub. Date: May 29, 2014

(54) PLANT CULTURING EQUIPMENT

(71) Applicant: Ming-Tsun Lin, Hsinchu County (TW)

(72) Inventor: Ming-Tsun Lin, Hsinchu County (TW)

(21) Appl. No.: 13/687,194

(22) Filed: Nov. 28, 2012

(51) Int. Cl. A01G 31/06

(52) U.S. Cl. CPC A01G 31/06
USPC 47/62 R

(57) ABSTRACT

A plant culturing equipment is composed of a plurality of planting walls, a plurality of lamp racks and a circulation fluid supply component, wherein the planting walls are mutually disposed in parallel, and the lamp rack is disposed relative to the planting walls to supply light source to the colonization board. The circulation fluid supply component is composed of connecting a plurality of fluid supply members, a fluid collection member, a plurality of pipes and a motor so as to form a circulation loop for the culture fluid. The fluid supply member is disposed onto the colonization board and fastened to the planting walls. The culture fluid is circularly utilized to supply plants. The plants are illuminated by the light source of the lamp board to replace natural light so as to control the speed of growing plants. The colonization board is pulled and pushed by the first sliding component.

### BACKGROUND OF THE INVENTION

1. Field of the Invention

The invention relates to a plant culturing equipment, and more particularly to a plant culturing equipment capable of enhancing the purpose of effective area utilization and circularly supplying culture fluid.

2. Description of the Related Art

A conventional large-scaled cultivated field usually utilizes open type planar soil agricultural land. Therefore, enormous areas are necessary and may be easily affected by weather to cause unstable production, and furthermore the land might be polluted by foreign creatures. The conventional cultivation manner is not suitable for modern people who live in the cities. Therefore, a manner of hydroponic cultivation is gradually in great demand in recent years. Hydroponic cultivation can allow most people who are restricted by living environment without additional spaces to utilize corners within the house to plant vegetables. It can prevent the vegetables having pesticide residues from being eaten and reduce much entertainment expenses while enjoying the planting fun.

Regarding the soil cultivation of conventional agriculture or hydroponic cultivation of quality agriculture, to increase the production of cultivation, cultivation personals merely consider increasing the quantity of cultivation boxes or planting containers along the level direction of land, thereby increasing the cultivation areas. However, in modern society that almost uses every inch of land, the remained land area will restrict the production of cultivation improved by cultivation personals if the cultivation areas are increased along the level direction of land.

Moreover, crops cultivation mainly utilizes related facilities to control energy resources, such as light illumination, water, weather and the like, to allow crops relying upon them such that yield having steady and higher quality can be obtained to enhance the output value of the yield. Although the space utilization of hydroponic cultivation is simpler than conventional soil tillage, the conventional hydroponic cultivation still takes hydroponic plant roots immersed with culture fluid as a principle. Further, light illumination and water are very important elements for growing and culturing plants. The growth of plants almost relies upon the progress of photosynthesis. Therefore, in many factors of affecting plant growth, sufficient light illumination condition may influence the growth quality of plants. Daily water supply irrigation has time and labor consuming Controlling plant environment in accordance with features of living habits and plant growth rule becomes an important link to culture crops.

In view of this issue, providing a plant cultivation manner capable of increasing cultivation area without occupying land areas that can be used and controlling the growth environment of plants in accordance with features of living habits and plant growth rule are a direction actively researched and developed by related persons dealing with vegetable, fruit, flower and crops cultivations.

### SUMMARY OF THE INVENTION

To overcome the foregoing shortcomings, an objective of the invention is to provide a plant culturing equipment that has a circulation loop without flowing the culture fluid away and can be repeatedly utilized to enhance the purpose of effective area utilization and circularly supplying culture fluid.

To achieve the foregoing objective, the plant culturing equipment of the invention is composed of a plurality of planting walls, a plurality of lamp racks and a circulation fluid supply component, wherein the planting wall is composed of a wall rack, a first sliding component and at least one colonization board. The colonization board is framed in the wall rack, and the colonization board is movably pulled and pushed from the wall rack through the first sliding component. The planting walls are mutually disposed in parallel, and the lamp rack is disposed relative to the planting walls to supply light source to the colonization board. The lamp rack is composed of a fastening rack, a second sliding component and lamp boards. The fastening rack frames at least one lamp board, and the lamp board is laterally moved within the fastening rack. The circulation fluid supply component is composed of connecting a plurality of fluid supply members, a fluid collection member and a plurality of pipes. The culture fluid placed in the fluid collection member is transported by the pipe to the fluid supply members to supply the colonization board, and the culture fluid then flows back to the fluid collection member via the pipe to form the circulation loop.

The whole equipment circularly utilizes the culture fluid to supply plants, and the plants are illuminated by the light source of the lamp board to replace natural light so as to control the speed of growing plants. The colonization board can be pulled and pushed from the wall rack through the first sliding component to achieve the stretching and retracting such that the culturing density of average unit area is greatly improved to further achieve the purpose of increasing the production of cultivated materials.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is a schematic diagram of a three-dimensional structure according to a first embodiment of the invention;

FIG. 2 is a structural schematic diagram according to the invention;

FIG. 3 is a schematic diagram of a three-dimensional structure according to a second embodiment of the invention;

FIG. 4 is a structural schematic diagram of a sliding component according to the invention;

FIG. 5 is another structural schematic diagram of a sliding component according to the invention;

FIG. 6 is a structural diagram of an application state according to the invention;

FIG. 7 is a plane graph of an application state according to the invention; and

FIG. 8 is a schematic diagram of an air conditioning structure according to the invention.

### DETAILED DESCRIPTION OF THE PREFERRED EMBODIMENTS

The technical content of the present invention will become apparent by the detailed description of the following embodiments and the illustration of related drawings as follows.

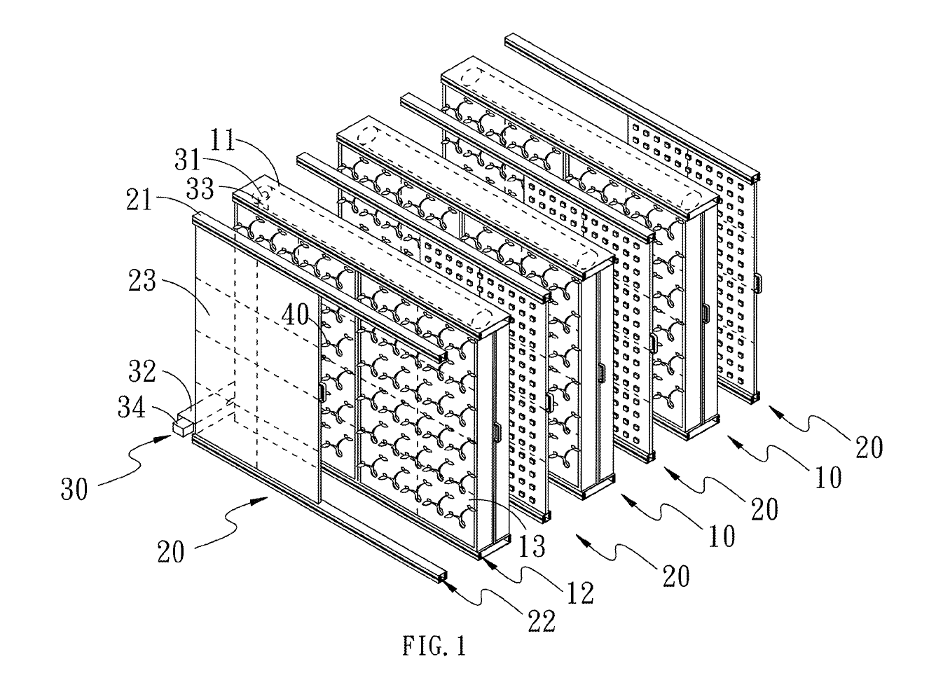

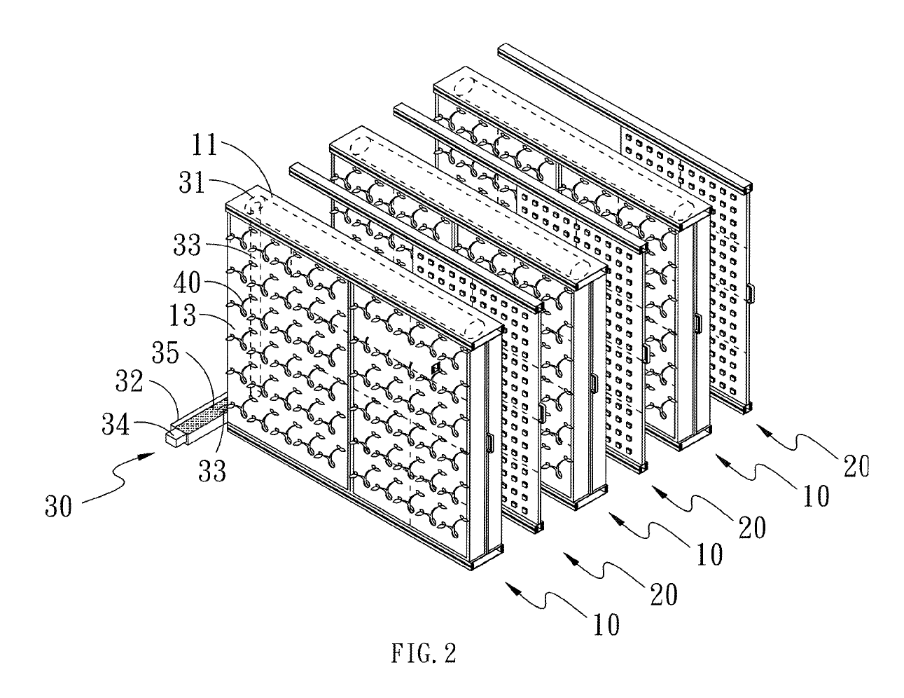

With reference to FIG. 1 and FIG. 2, the plant culturing equipment of the invention is composed of a plurality of planting walls 10, a plurality of lamp racks 20 and a circulation liquid supply component 30.

The planting walls 10 are mutually disposed in parallel. The planting wall 10 is composed of a wall rack 11, a first sliding component 12 and at least one colonization board 13. The colonization board 13 is farmed to the wall rack 11. The colonization board 13 is movably pulled and pushed from the wall rack 11 through the first sliding component 12.

The lamp rack 20 is disposed relative to the planting wall 10 to supply light source to the colonization board 13. The lamp rack 20 is composed of a fastening rack 21, a second sliding component 22 and a lamp board 23. The fastening rack 21 is framed to at least one lamp board 23. The lamp board 23 is laterally moved in the fastening rack 21 through the second sliding component 22.

The circulation liquid supply component 30 is composed of connecting a plurality of fluid supply members 31, a fluid collection member 32, a plurality of pipes 33 and a motor 34. The position and upper portion of the fluid supply member 31 that is relative to the colonization board 13 is fastened to the wall rack 11, and the culture fluid 35 within the fluid collection member 32 is transported to the fluid supply member 31 from the pipe 33 to supply the colonization board 13. The culture fluid 35 flows back to the fluid collection member 32 via the pipes 33 to form a circulation loop.

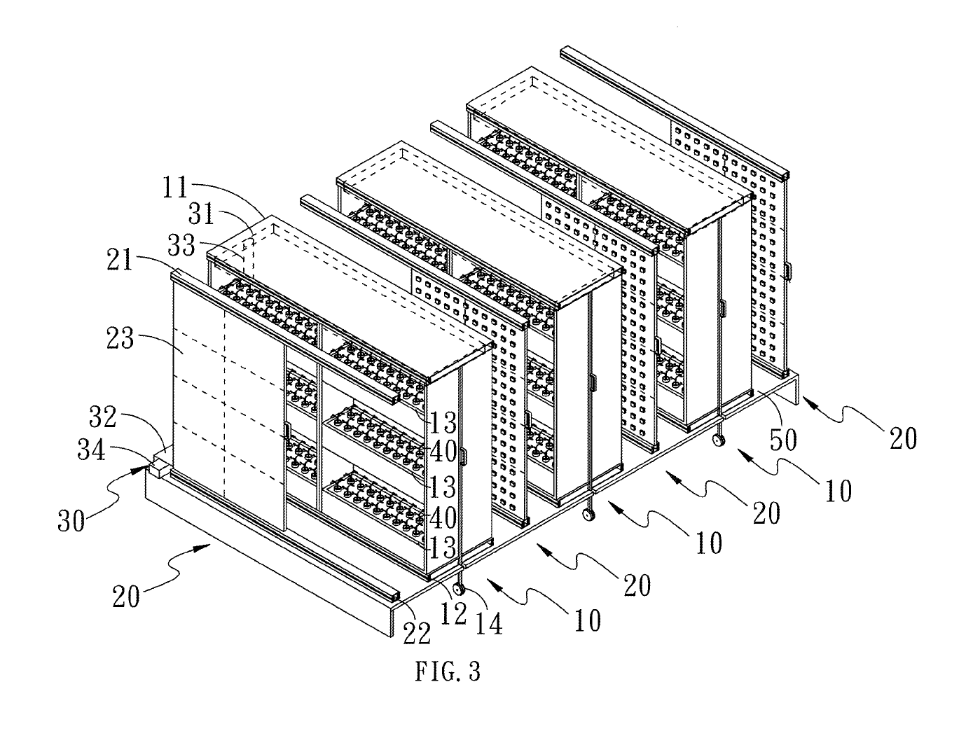

While in implementation, FIG. 1 shows a first embodiment. The colonization boards 13 are framed to the wall rack 11. These colonization boards 13 are vertically spaced to each other or backwardly framed to the wall rack 11. Alternatively, FIG. 3 shows a second embodiment. The colonization boards 13 are levelly framed to the wall rack 11 in layer. Each colonization board 13 has a plurality of through holes 131 for positioning and culturing plantlet. The colonization board 13 can be pulled, pushed, and moved from the wall rack 11 through the first sliding component 12 so as to achieve stretching and retracting. It does not only achieve the change of the operating space of the colonization board 13 to provide working personals with movable spaces during the culturing, plantlet moving or cropping but also improves the culturing density of average unit area so as to further achieve the purpose of increasing the production of cultivated material.

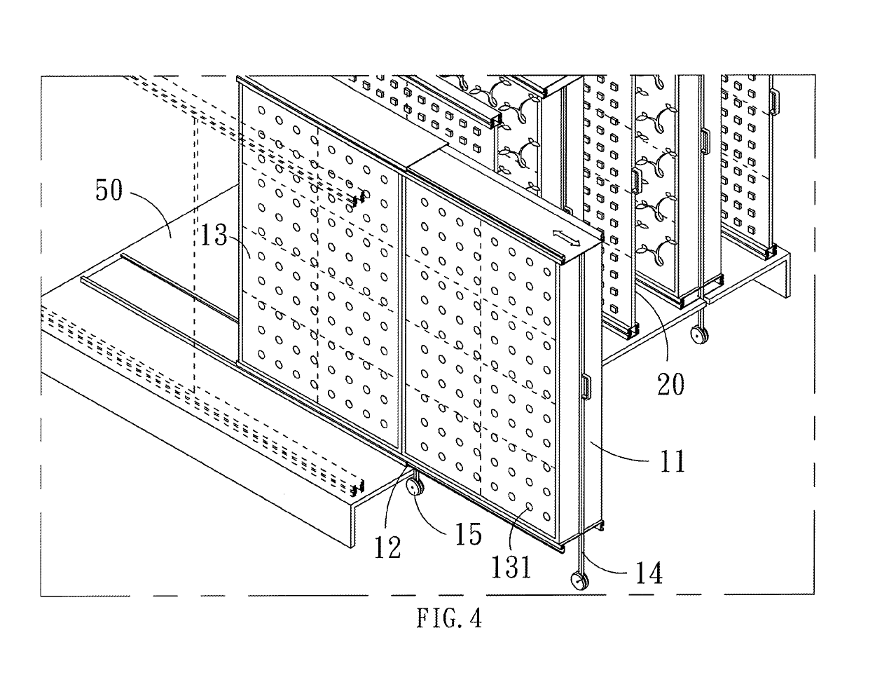

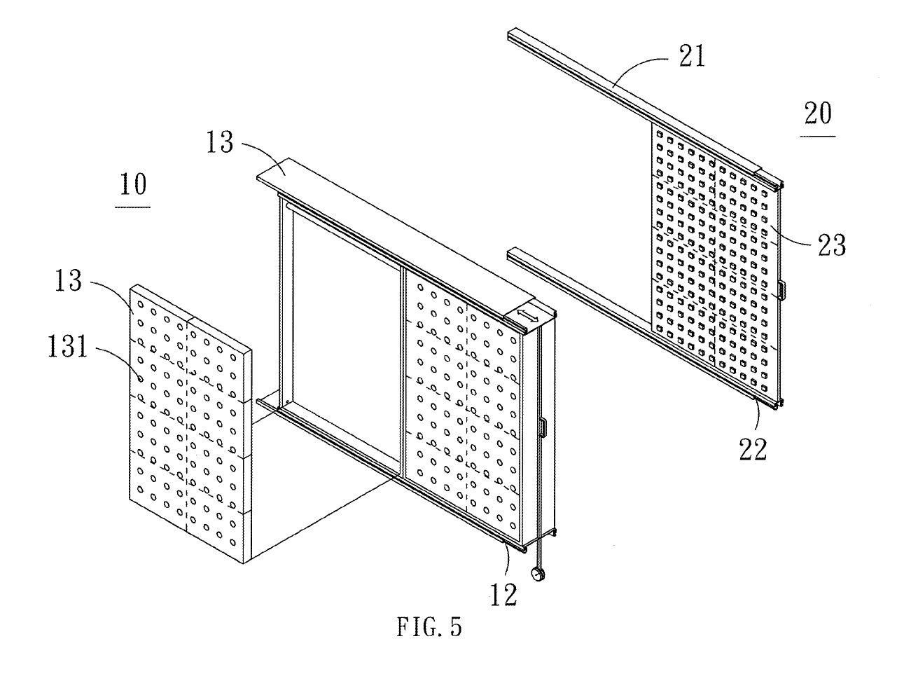

Of course, as shown in FIG. 4, the first sliding component 12 can be pulleys and a sliding rail structure. The wall racks 11 are disposed with pulleys, and the colonization board is disposed with the sliding rail to allow the colonization board 13 sliding and displacing between the wall racks 11. Alternatively, the wall racks 11 are disposed with the sliding rail, and the colonization board 13 is disposed with the pulleys to allow the colonization board 13 sliding and displacing between the wall racks 11. In addition, as shown in FIG. 5, the first sliding component 12 can be a correspondingly sliding block and a sliding bar structure. The wall racks 11 are disposed with the sliding block, and the colonization board 13 is disposed with the sliding bar to allow the colonization board 13 sliding and displacing between the wall racks 11. Alternatively, the wall racks 11 are disposed with the sliding bar, and the colonization board 13 is disposed with the sliding block to allow the colonization board 13 sliding and displacing between the wall racks 11.

Secondary, the position and upper portion of the wall rack 11 that is relative to the colonization board 13 are fastened with the fluid supply members 31. When the motor 34 works, the culture fluid 35 within the fluid collection member 32 is transported by the pipe 33 to each fluid supply member 31. The culture fluid 35 is delivered by the fluid supply member 31 to the colonization board 13 in the split-flow or mist-spraying manner such that the seeding 40 on each colonization board 13 can sufficiently absorb the culture fluid 35, and furthermore the culture fluid flows back to the fluid collection member 32 via the pipe 33 to form the circulation loop so that the culture fluid 35 can be circularly utilized without flowing away.

Moreover, the planting wall 10 is disposed with the lamp rack 20 relative to the front of the colonization board 13. The lamp board 23 can be laterally moved within the fastening rack 21 through the second sliding component 22. The second sliding component 22 can be automatically controlled or manually controlled to allow the colonization board 13 of the planting wall 10 to receive light source projected by the lamp board 23 in turn such that natural light can be replaced, and plant growth speed can be controlled. Of course, the second sliding component 22 can be correspondingly pulleys and sliding rail structure. The fastening racks 21 are disposed with the pulleys, and the lamp board 23 is disposed with the sliding rail to allow the lamp board 23 sliding and displacing between the fastening racks 21. Alternatively, the fastening racks 21 are disposed with the sliding rail, and the lamp board 23 is disposed with the pulleys to allow the lamp board 23 sliding and displacing between the fastening racks 21. In addition, the second sliding component 22 can be correspondingly sliding blocks and the sliding bar. The fastening racks 21 are disposed with the sliding blocks, and the lamp board 23 is disposed with the sliding bar to allow the lamp board 23 sliding and displacing between the fastening racks 21. Alternatively, the fastening racks 21 are disposed with the sliding bar, and the lamp board 23 is disposed with the sliding blocks to allow the lamp board 23 sliding and displacing between the fastening racks 21.

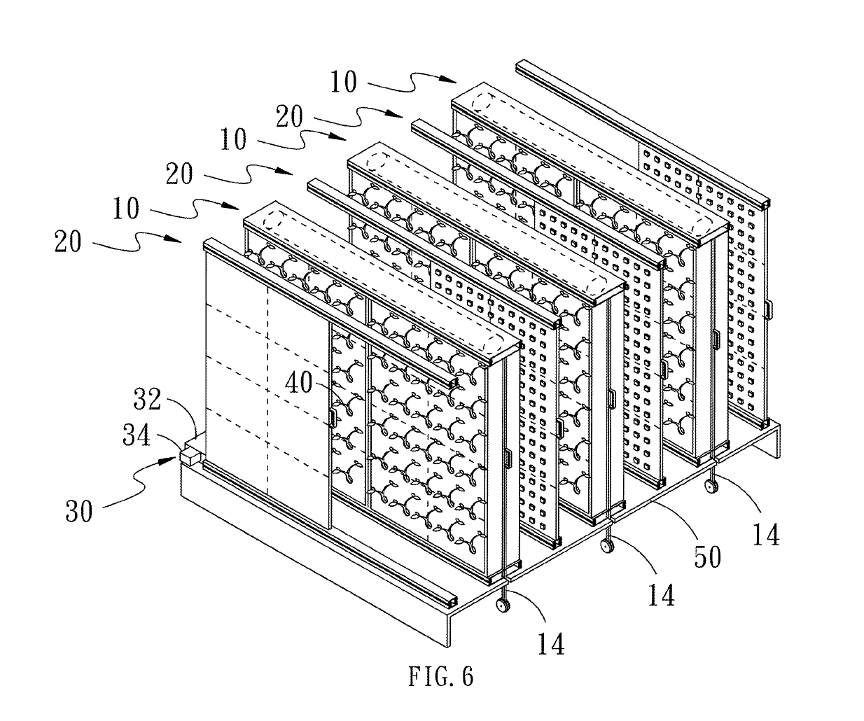

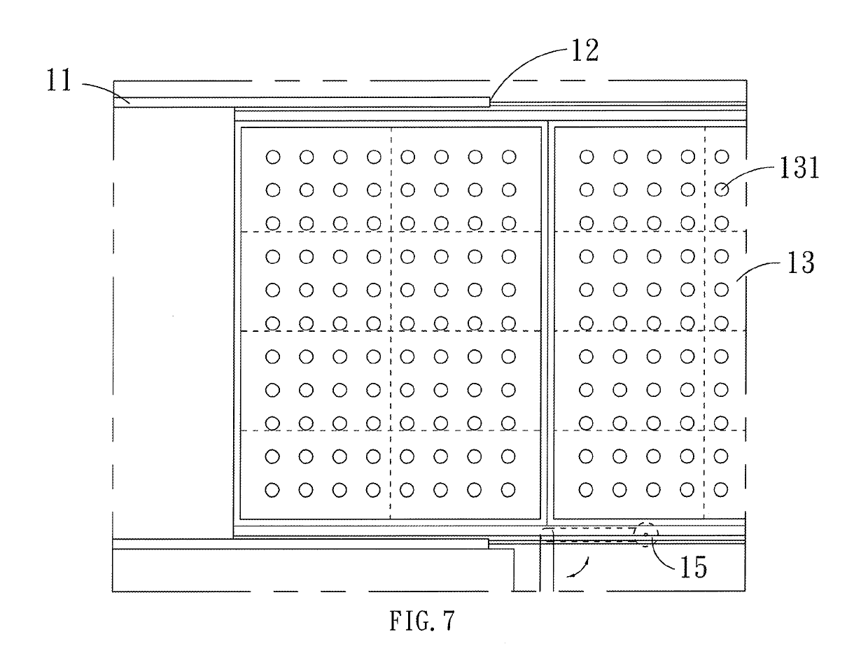

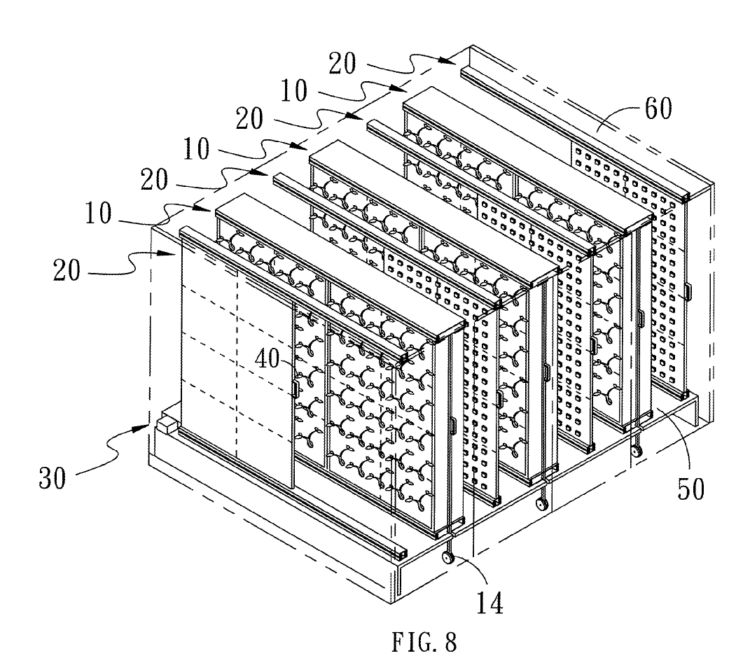

Further, as shown in FIG. 6 and FIG. 7, a plurality of planting walls 10, a plurality of lamp racks 20 and a circulation fluid supply component 30 are combined and fastened to a rack board 50. The planting wall 10 is disposed with a plurality of fastening wheels 14. Supporting wheels 15 capable of being folded are disposed between the fastening wheels 14. It does not only facilitate the colonization board 13 sliding and displacing between the wall racks 11 but also conveniently moves and displaces the whole equipment. Moreover, as shown in FIG. 8, the whole equipment can be combined in an air conditioning room 60 having a containing space to regulate indoor temperature and humidity such that the environment of growing plants can be stably controlled, and growth benefit of plant seeding can be speeded up.

While the means of specific embodiments provided by the present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A plant culturing equipment, comprising:
a plurality of planting walls mutually disposed in parallel, the planting walls composed of a wall rack, a first sliding component and at least a colonization board, the colonization board framed to the wall rack, the colonization board movably pulled and through by the first sliding component;
a plurality of lamp racks disposed relative to the planting wall to supply light source to the colonization board, the lamp racks composed of a fastening rack, a second sliding component and a lamp board, the fastening rack framing at least a lamp board, the lamp board laterally moved within the fastening rack through the second sliding component;
a circulation fluid supply component composed of connecting a plurality of fluid supply members, a fluid collection member, a plurality of pipes and a motor, a position and an upper portion of the fluid supply member that is relative to the colonization board fastened to the wall rack, a culture fluid within the fluid collection member transported by the pipes to the fluid supply member to supply the colonization board, the culture fluid then flowing back to the fluid collection member via the pipes to form a circulation loop.

2. The plant culturing equipment of claim 1, wherein the colonization boards are adjoined to each other and stood and framed to the wall rack, and the colonization board has a plurality of through holes.

3. The plant culturing equipment of claim 2, wherein the first sliding component and the second sliding component are correspondingly pulleys and a sliding rail structure.

4. The plant culturing equipment of claim 2, wherein the first sliding component and the second sliding component are correspondingly sliding blocks and a sliding bar structure.

5. The plant culturing equipment of claim 2, further combining a rack board, wherein the plurality of planting walls, the plurality of lamp racks and a circulation fluid supply component are disposed to the rack board, and the planting walls are disposed with a plurality of fastening wheels.

6. The plant culturing equipment of claim 2, wherein the planting wall is disposed with a supporting wheel, and the supporting wheel is disposed between the fastening wheels and is folded.

7. The plant culturing equipment of claim 2, further combining an air conditioning room having a containing space, wherein the air conditioning room is disposed with the plurality of planting walls, the plurality of lamp racks and a circulation fluid supply component to control indoor temperature and humidity.

8. The plant culturing equipment of claim 1, wherein the colonization boards are framed to the wall rack in layer, and the colonization board has the plurality of through holes that are disposed in rows.

9. The plant culturing equipment of claim 8, wherein the first sliding component and the second sliding component are respectively correspondingly pulleys and the sliding rail structure.

10. The plant culturing equipment of claim 8, wherein the first sliding component and the second sliding component are correspondingly sliding blocks and a sliding bar structure.

11. The plant culturing equipment of claim 8, further combining a rack board, wherein the plurality of planting walls, the plurality of lamp racks and a circulation fluid supply component are disposed to the rack board, and the planting walls are disposed with a plurality of fastening wheels.

12. The plant culturing equipment of claim 8, wherein the planting wall is disposed with a supporting wheel, and the supporting wheel is disposed between the fastening wheels and is folded.

13. The plant culturing equipment of claim 8, further combining an air conditioning room having a containing space, wherein the air conditioning room is disposed with the plurality of planting walls, the plurality of lamp racks and a circulation fluid supply component to control indoor temperature and humidity.
